(19) United States
(12) Patent Application Publication
(10) Pub. No.: US 2023/0109212 A1
(43) Pub. Date: Apr. 6, 2023

(54) COMPOSITE BOLT CAP

(71) Applicant: ANTHONY L. HUGHES, BUENA VISTA, CO (US)

(72) Inventor: ANTHONY L. HUGHES, BUENA VISTA, CO (US)

(21) Appl. No.: 17/493,954

(22) Filed: Oct. 5, 2021

(51) Int. Cl. F16B 37/14

(52) U.S. Cl. CPC F16B 37/14; E03D 11/16

(57) ABSTRACT

A fastening hardware system for a light or medium-duty application, which consists of a composite cap having an outer cylindrical wall, a distal end of the composite cap enclosed, the composite cap having a levelled base and a proximal threaded opening, the opening leading into an internal cavity of the composite cap, the threaded opening including an inner threaded cylindrical wall adapted to receive the distal base of a bolt, the composite cap received on the bolt such that rotation of the composite cap in a direction of rotation securely tightens the composite cap on the base of the bolt, and the cap being inhibited apart rotation of the composite cap in a direction of loosening the composite cap from the threaded shaft of the bolt. The device can be used for any light or medium duty application, including but not limited to home toilet installation, knock-down furniture assembly, wall signage and panel installation, as well as auto license plate attachment.

### CROSS REFERENCE TO RELATED APPLICATION(S)

Not Applicable.

### BACKGROUND OF THE INVENTION

### Field of the Invention (Technical Field)

The present invention pertains generally to the field of hardware and installation for any light or medium-duty application. The invention pertains more particularly towards fasteners used between any object, which may include the fastening of a typical bolt cap application to an object. A full description of the prior art will be discussed in detail below and is not included in this section. However, the invention resolves a need in the hardware field and may be used by professionals or individuals alike.

### Description of the Prior Art (Background)

Numerous types of standard fastening systems have been developed which consist of a metal bolt, a beauty cap plate, a metal washer, a metal nut and finally, a beauty cap. The objective of the fastener is to provide a means of securing an object to a flat surface. Prior art toilet fastening systems consist of multiple parts that may become loose or deteriorated and frequently need replacement. These options often fail to meet the needs of the industry and consumers alike.

These and other options are shown in several U.S. patents that have been granted on fastening hardware. U.S. Pat. No. 10,060,115 issued to AIIM, LLC discloses a bolt, a nut, and a cap. The three-piece invention fastens the base of the toilet to the toilet flange. The cap conjoined with the nut acts as a single part during installation of initial tightening of the nut onto the bolt, re-tightening of the nut onto the bolt, and loosening the nut from the bolt. Patent '115 does not have a cap that can fasten a toilet bowl to the toilet flange by itself. The nut itself functions as the fastening mechanism of the invention. The cap functions as a tool to fasten the nut onto the bolt, which eliminates the use of tools required to fasten a nut to the bolt. Although the cap in the '115 patent has tightening/loosening mechanisms, it still requires the fastening mechanism of an actual nut to secure the toilet bowl to the toilet flange. The cap in '115 patent has no fastening mechanism.

U.S. Pat. No. 10,322,662 issued to Danco, Inc., discloses a fastener assembly with an adjustable length bolt, tightening members, tightening tool, and a decorative cap whereby the low-profile bolt cap attaches to a tightening tool. The cap serves a decorative function to conceal the tightening tool. Its cap is a superficial piece that covers the unattractive tightening tool of the toilet fastening system. The cap in the '296 patent has no fastening mechanism.

U.S. Pat. No. 10,246,866 issued to Charles Hugh Junca discloses a fastener, a washer and a cap whereby the three-piece fastening system secures the toilet bowl to the toilet flange by fastening the cap onto a bolt constructed specifically to fit the inner cavity of the cap. The Junca device consists of a fastener which is secured within a slot of a toilet flange. Once the toilet bowl is placed on top of the toilet flange, the threaded shaft of the fastener protrudes upward and is visible outside of the toilet bowl. After placing the washer onto the fastener, the cap is then mounted onto the fastener. By rotating the cap, the cap tightens on the fastener and secures it to the toilet flange. The cap in the '778 patent is designed for a specific fastener (bolt) while the presently disclosed invention can fasten onto a standard hex flange bolt used in a typical toilet fastening system.

Anyone who has attempted to perform any light or medium-duty application, for example a toilet installation, has no doubt experienced frustration. In a conventional toilet installation, the toilet base is secured with a threaded bolt that is positioned to be insertable upwardly through an aperture or bolt hole disposed on each side of the toilet base. A nut is then threaded into the bolt. A washer is often used between the toilet base and the nut, and the nut is tightened with a wrench and then covered with a decorative cap or bolt cover. Conventional bolt covers can also have a height equal to or greater than the diameter of the base, which is needed if a substantial portion of the bolt length remains exposed above the nut. Because of the multiple installation parts, this leaves several variable factors which can cause significant problems.

The present invention structure is not disclosed in the prior art. Unlike the prior art, the previously disclosed invention only consists of a one-piece structure, comprising of a composite bolt which is not a superficial beauty cap, but is used for fastening to all types of standard bolts. These conventional bolt assemblies and methods pose several common problems that establish a need for an improved technology. First, bolt caps can be difficult to clean. Likewise, given the potentially damp environment, metallic hardware such as the nut and washer, may rust and become very difficult to remove. Second, under the currently known practice, the nut underneath the lip of the toilet bowl is retained by hand or with hand or pliers. A screwdriver is also utilized to try to unscrew the bolt. Usage of such tools further complicates the process because over-tightening may crack or fracture a toilet base, causing additional frustration. To add to the already extensive list of problems, several different types of nuts are used for securing the bolt cap to the bolt, and failure to use the correct tool causes damage to the nut, resulting in the problems described above.

In view of the above and without being exhaustive, there is a need to overcome the aforementioned drawbacks. What is clearly needed is a fastening hardware system for a light or medium-duty application that does not rust or deteriorate, does not allow the nut to back off and become loose, does not require additional tools for tightening and repair, and allows for simple installation through the use of a standard hex flange bolt. Accordingly, the present disclosed subject matter seeks to resolve these technical difficulties and successfully comprises the present invention with advantageous technical effects after research and development.

### SUMMARY OF THE INVENTION

In one form of the present invention, the composite bolt cap includes a tool-less, reusable, easy to use, non-corrosive, single piece fastening hardware for a light or medium duty application. In the same form of this invention, the composite bolt cap supersedes prior art and will be made out of a non-corrosive material preferably, but not limited to a plastic, composite, ceramic, or non-metallic substance. The present invention supersedes other toilet fasteners by providing a superior fastening of suitable devices where a single piece fastening mechanism composite bolt cap attaches to a standard hex flange bolt. This invention functions to completely fasten the toilet bowl while most toilet fastening systems have either solely a decorative beauty function or a decorative and tightening function with multiple parts. The primary fastening device of most toilet fastening is often the nut. The present invention incorporates the fastening mechanism of the nut into the present structure, which eliminates the use of a nut and the tools needed to secure the nut to the bolt. With this invention, a person can secure a toilet bowl to a toilet flange by simply screwing on the composite cap to the bolt. The present structure incorporates the functions of both a composite cap and a fastening tool unlike other toilet fastening systems, which usually use the cap as just a decorative piece.

The present invention will not cause rust or deterioration as the non-corrosive material for the composite cap will eliminate the necessity of having to replace the fastening system on a regular basis, which occurs with most toilet fastening systems. Additionally, the present invention desirably provides a clean and attractive surface at the bolt attachment locations and facilitates routine cleaning while also limiting exposure of the upper portions of the fastener assembly to contact with potentially corrosive fluids.

The illustrated embodiment of the presently disclosed invention has a semi-cylindrical shape with a rounded composite cap top and a generally curved rear-side, the composite cap's proximal base being internally threaded. The flat bottom surface of the composite cap's inner cavity includes four locking members, which secure onto the threaded portion of the standard hex flange bolt. While receiving the standard hex flange bolt, the composite cap fastens through a continuing rotating mechanism.

The present invention is advantageous because the composite bolt cap will screw securely onto the bolt and cannot be accidentally removed, loosened or removed and will not require a variety of hardware devices for installation and mounting. Thus, a consumer does not need to waste time replacing the bolt cap or cleaning the bolt cap, thereby saving time and money.

It will be appreciated by those of skill in the art upon reading this disclosure that various alterations and modifications to the embodiment particularly disclosed can be made within the scope of the invention. Related objects and advantages of the present invention will be apparent from the following detailed description of an illustrative embodiment of the invention, reference being made to the accompanying drawings.

### BRIEF DESCRIPTION OF THE DRAWING

For a more complete understanding of this disclosure and its features, reference is now made to the following description, taken in conjunction with the accompanying drawings. The components in the figures are not necessarily to scale, emphasis instead being placed upon illustrating the principles of the invention. In the figures, like reference numerals designate corresponding parts throughout the different views.

FIG. 1 is an exploded view illustration of the fastening of a toilet using the composite bolt cap hardware of the present invention.

FIG. 2 is a side view illustration of the composite bolt cap.

FIG. 3 is a bottom view of the inner cavity of the composite bolt cap.

FIG. 4 is a cross-section view of the present invention's proximal base being internally threaded.

### DETAILED DESCRIPTION OF THE INVENTION

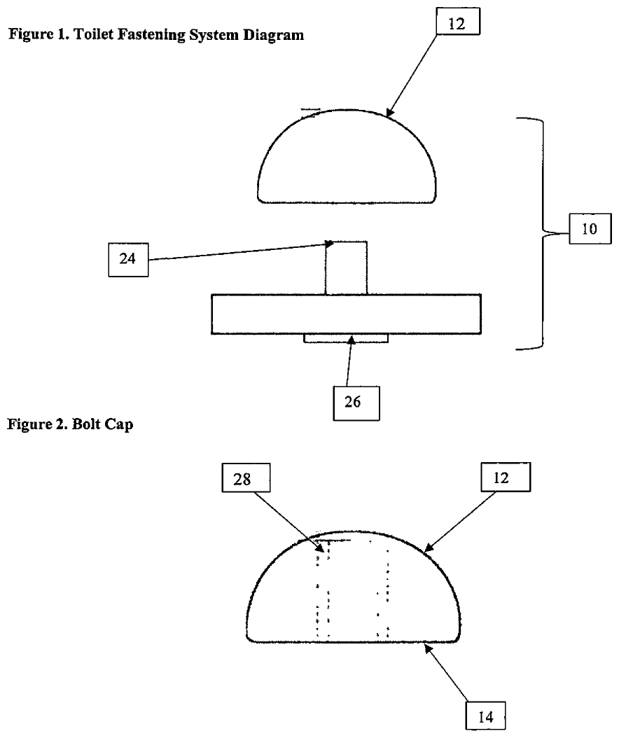

The invention will now be described in detail hereinafter with reference to the accompanied drawings. FIGS. 1 through 3, described below, and the description of the principles of the present disclosure are by way of illustration only, and should not be construed in any way to limit the scope of the disclosure. Unless defined otherwise, all technical and scientific terms used herein have the same meaning as commonly understood to one of ordinary skill in the art to which this invention relates. Those skilled in the art will understand that the scope of the present discourse may be implemented or suitably arranged use in any light or medium duty application where a finishing composite bolt cap is attached to a bolt. Those skilled in the art will also recognize that the composite bolt cap is not limited to bathrooms or to any particular type of room. Rather, the composite bolt cap is one of general applicability and is suitable for use in any type of light or medium-duty application.

Although any methods, devices and materials similar or equivalent to those described can be used in the practice or testing of the invention, the exemplary methods, devices and materials are now described. FIG. 1 is one implementation of a medium-duty application, a toilet installation and fastening system 10. Although FIG. 1 depicts one type of medium-duty application, various changes may be made to FIG. 1. For example, the exact placement, shape and quantity of the installation could vary depending on the embodiment.

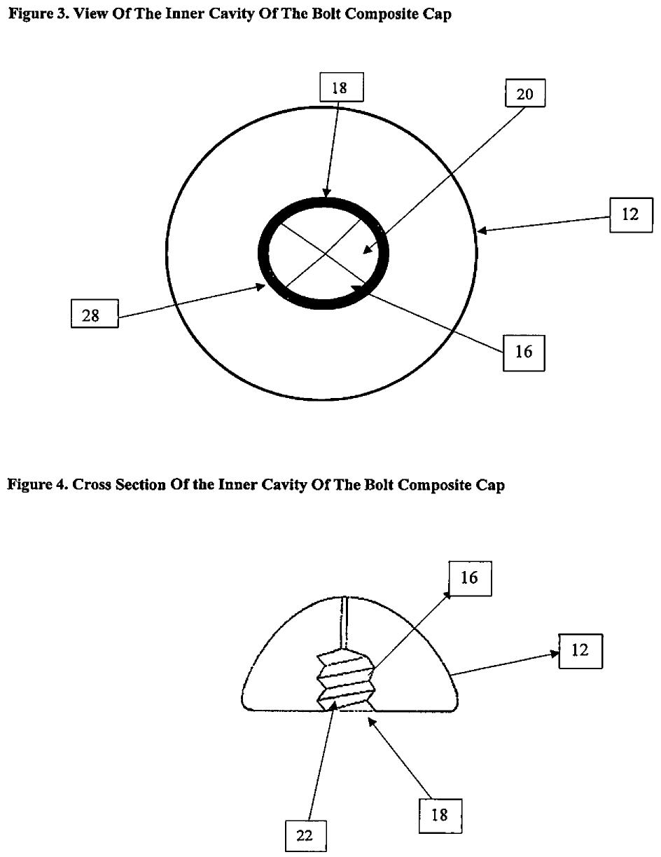

FIGS. 1-4 show the composite bolt cap 12, when viewed from the side has a semi-cylindrical shape. Referring to FIG. 3 is a bottom view of the composite bolt cap 12, showing a generally flat bottom surface 14 of the composite cap 12 that secures to the bottom surface of the bolt 24. FIG. 3 shows the bolt receiving portion of the cap 12 comprises a hollow cylindrical opening 18 and a threaded inner wall 16 (FIG. 4) of the hollow cylindrical opening 18. The threaded inner wall 16 is configured to selectively thread to the end 24 of the bolt 26. The inside locking portion of the bolt sleeve 28 has more than two locking members 20 formed to engage the circumference of the bolt 26.

What is claimed is:

1. A fastening hardware system for a light or medium-duty application comprising:
a. a composite cap having an outer dome-shaped wall, a distal enclosed end of the composite cap,
b. the composite cap having a levelled base and a proximal threaded opening, the opening leading into an internal cavity of the composite cap,
c. the threaded opening including an inner threaded cylindrical wall, the threaded opening adapted to receive the distal base of a threaded bolt, rotation of the composite cap in a first direction of rotation securely tightening the composite cap on the bolt, and
d. the rotation of the composite cap in a second direction adopted to loosen the cap from the threaded shaft of the bolt.

2. The fastening hardware system for a light or medium-duty application of claim 1, wherein the cap has a rounded top and a generally curved side wall.

3. The fastening hardware system for a light or medium-duty application of claim 1, wherein the threaded opening of the internal cavity of the composite cap includes is adopted to receive an upper foot of the bolt when the composite cap is conjoined with the bolt.

4. The fastening hardware system for a light or medium-duty application of claim 1, wherein an inside locking portion of the composite cap includes a plurality of locking members adapted to engage the circumference of the bolt.

5. The fastening hardware system for a light or medium-duty application of claim 1, the composite cap having a generally flat bottom surface, the flat surface adapted to engage a surface of a base of a structure.

6. The fastening hardware system for a light or medium-duty application of claim 1, wherein first and second locking members of the bolt sleeve create a tactile feedback during rotation of the composite cap onto the bolt in the tightening direction.

7. The fastening hardware system for a light or medium-duty application of claim 8, wherein the first and second locking members of the bolt sleeve create a tactile feedback during receiving bolt in the tightening direction.
